(19) United States
(12) Patent Application Publication
(10) Pub. No.: US 2005/0162788 A1
(43) Pub. Date: Jul. 28, 2005

(54) Differential protection device with simplified protection parameter adjustment means

(75) Inventor: Dominique Boudaud, Voiron (FR)

Correspondence Address: PARKHURST & WENDEL, L.L.P., 1421 PRINCE STREET, SUITE 210, ALEXANDRIA, VA, 22314-2805, US

(73) Assignee: Schneider Electric Ind. SAS, Rueil Malmaison (FR)

(21) Appl. No.: 11/023,410

(22) Filed: Dec. 29, 2004

(30) Foreign Application Priority Data
Jan. 22, 2004 (FR) 0400605

(51) Int. Cl. H02H 3/00

(52) U.S. Cl. 361/42

(57) ABSTRACT

Differential protection device comprising differential current measuring means, and a processing unit comprising means for adjusting the fault current threshold setting and means for adjusting a time delay, the processing unit being connected to said measuring means to receive a signal representative of a differential current. The means for adjusting the fault current threshold setting comprise switching means having a contact able to take at least two positions to select a fault current threshold for each of the positions, and to select for at least one of said positions a minimum or reduced time delay value whatever the initial setting of the time delay setting means.

### BACKGROUND OF THE INVENTION

The invention relates to a differential protection device comprising:
differential current measuring means, and
a processing unit comprising means for adjusting the fault current threshold setting and means for adjusting a time delay setting, the processing unit being connected to said measuring means to receive a signal representative of a differential current.

The invention also relates to a circuit breaker comprising such a differential protection device.

### STATE OF THE ART

In known manner, as illustrated in FIG. 1, the differential protection device comprises current measuring means 1 connected to a processing unit 2. The measuring means are generally electric current sensors supplying a signal representative of the differential currents which can flow in electric current lines 3.

This type of differential protection device is generally associated with an opening mechanism 32 of contacts 30 placed in series with the electric current lines.

The differential protection device enables protection of circuits in combination with a wide current and time delay range. The tripping order generally causing opening of the contacts is generated when the value of the current signals exceeds a preset threshold for a preset time.

Furthermore, the processing unit of the electrical device comprises a tripping circuit 4 connected to adjustment means 5 comprising first means for setting a current threshold and second means for setting the time delay value.

To perform the current and time delay threshold settings, it is well known to use potentiometers or a selector switch with several positions.

Electrical differential protection devices designed for protection of human beings have their own safety requirements imposed by regulations. Thus, when the protection rating is chosen to protect human beings, the standard imposes that the tripping time delay be minimal or zero.

To meet this safety imperative specific to protection of human beings, certain known protection devices comprise a simultaneous twofold setting of the tripping threshold and of the minimum time delay value. In known manner, a specific selector switch with two switching circuits is indispensable to perform the two setting operations. To perform said settings, the specific selector switch does in fact have to simultaneously actuate two distinct contacts by means of the same control means of said selector switch. This type of specific selector switch is complex to achieve, costly and unreliable. The volume occupied by such a selector switch is large.

### SUMMARY OF THE INVENTION

The object of the invention is to remedy the shortcomings of the state of the art by proposing a differential protection device, comprising means for adjusting the current setting and time delay setting, that is simple and economical to manufacture and occupies a small volume.

A differential protection device according to the invention comprises differential current measuring means, a processing unit comprising means for adjusting the fault current threshold setting and means for adjusting a time delay setting, the processing unit being connected to said measuring means to receive a signal representative of a differential current, and comprising means for adjusting the fault current threshold setting having switching means with a contact able to take at least two positions to select a fault current threshold for each of the positions, and to select for at least one of said positions a minimum or reduced time delay value whatever the initial setting of the means for adjusting the time delay setting.

In a particular embodiment, said switching means comprise a common point connected to a reference line and connected to outputs, at least a first minimum time delay selection output being connected to said means for adjusting the time delay setting to supply a minimum time delay control signal and at least a second fault current threshold selection output being connected to at least one rating change resistor.

According to a development of the invention, the device comprises a minimum time delay selection output polarized by a polarization line.

Advantageously rating change resistors are connected in parallel with the current measuring means, via the contact of the switching means.

Advantageously rating change resistors are connected in series with the current measuring means, via the contact of the switching means.

The switching means are preferably formed by an axially-operated rotary selector switch.

The means for adjusting the current threshold setting preferably select said minimum time delay value by supplying a minimum time delay control signal to time delay cancelling means of the processing unit.

According to a development of the invention, the means for adjusting the time delay setting comprise a variable resistor mounted in series with a capacitor connected to a reference line and the time delay cancelling means control opening or closing of the connection between said capacitor and the reference line.

Advantageously, the time delay cancelling means comprise an input to receive the minimum time delay control signal, comparison means to compare said control signal with a reference threshold and interruption means connected in series with the time delay capacitor to reduce or cancel the time delay of a trip.

A circuit breaker according to an embodiment of the invention comprises opening contacts connected to electric current lines, a relay to command opening of said contacts via a mechanism, a differential protection device as defined above comprising the differential current measuring means arranged on said current lines, a processing unit supplying a tripping signal to said relays if a fault is detected and means for adjusting the current threshold setting having a position to select a minimum time delay value.

### BRIEF DESCRIPTION OF THE DRAWINGS

Other advantages and features will become more clearly apparent from the following description of a particular embodiment of the invention, given as a non-restrictive example only and represented in the accompanying drawings in which:

FIG. 1 represents a general block diagram of a differential protection device of known type;

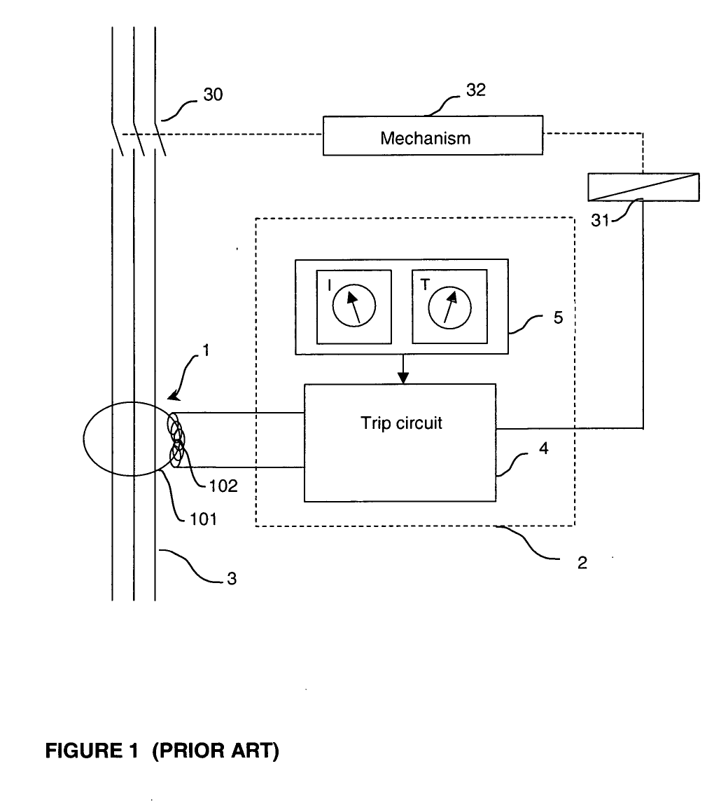

FIG. 2 represents a general block diagram of a differential protection device according to an embodiment of the invention;

FIG. 3 represents a detailed block diagram of a differential protection device according to an embodiment of the invention;

FIG. 4 represents an alternative embodiment of the means for adjusting the current threshold setting according to another embodiment of the invention.

### DETAILED DESCRIPTION OF AN EMBODIMENT

A protection device comprises at least two protection parameter adjustment means. These protection parameters are mainly related to the fault current threshold and to the time delay, i.e. the time during which the electric fault current can flow.

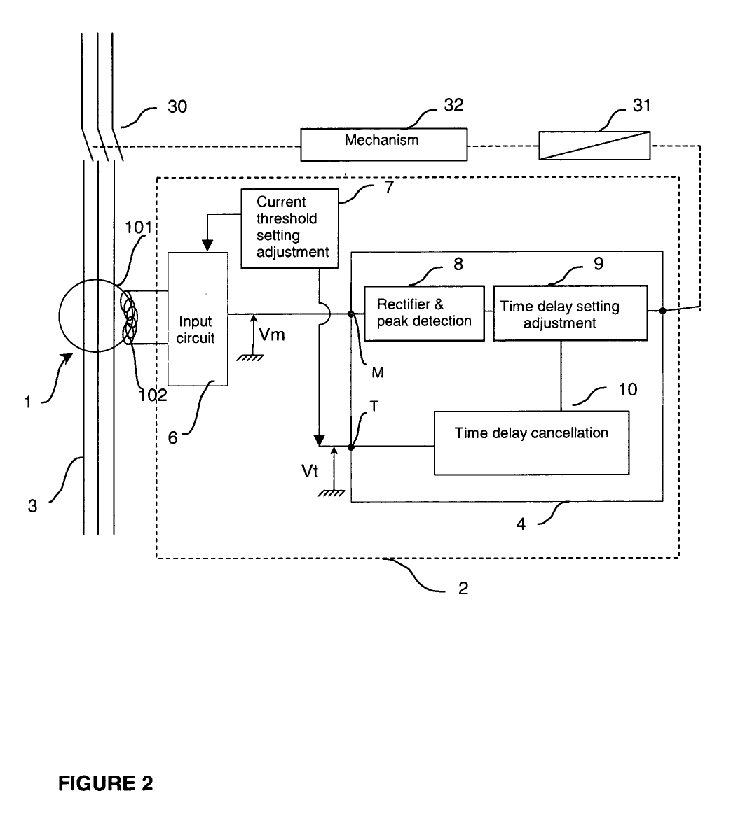

According to an embodiment of the invention, FIG. 2 shows in block diagram form a protection device comprising current sensors 1, a trip circuit 4, and means for adjusting the fault current threshold setting 7 and the time delay setting 9.

The current sensors 1 comprise a measuring toroid with a magnetic circuit 101 arranged around the conductors of the current lines 3 to be protected. Thus, the current lines 3 form the primary winding of the measuring toroid. A secondary winding 102 is connected to an input circuit 6 of the processing unit 2. The secondary winding 102 supplies the circuit 6 with a signal representative of a differential current able to flow in the electric current lines 3.

The input circuit 6 then supplies a voltage signal Vm to the trip circuit 4 via a measurement input M. This first signal Vm is representative of the differential electric current measured by the current sensors 1. The voltage signal Vm also depends on the current threshold fixed with the means for adjusting the fault current threshold setting 7.

In practice, an output of the input circuit 6 is connected to a rectifier and peak detection circuit 8 which supplies a rectified voltage to the means for adjusting the time delay setting 9. As soon as a sufficient peak voltage is measured at the output of the rectifier 8, the trip circuit 4 can supply an order after a more or less long time delay.

Furthermore, the means for adjusting the fault current threshold setting 7 set the value of a second signal supplied to the trip circuit 4 via a time delay input T. This second signal Vt dependent on the current threshold chosen is supplied to time delay cancellation control means 10. Depending on its value, this voltage Vt modifies or doesn't modify the value of the time delay set beforehand by the means for adjusting the time delay setting 9.

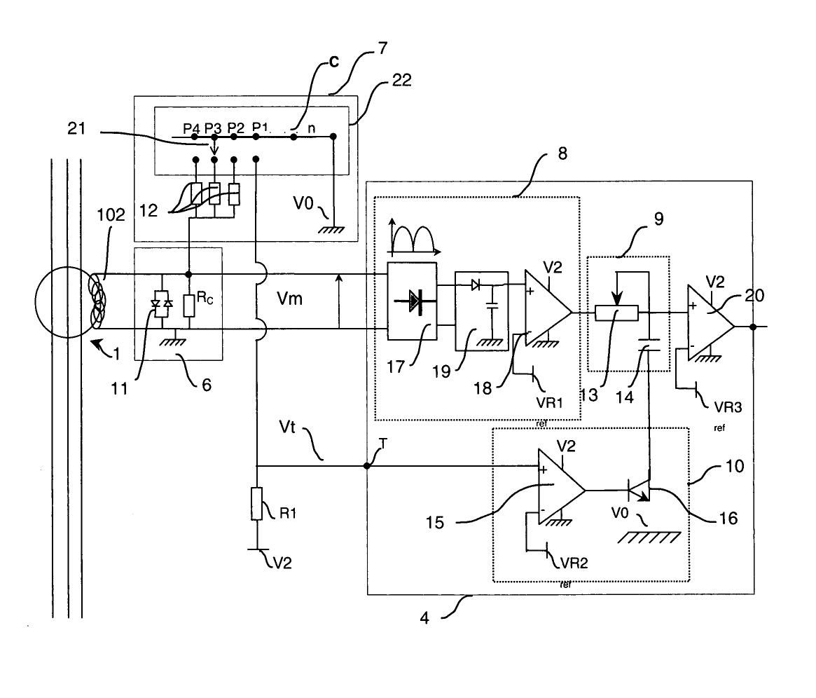

According to FIG. 3, the secondary circuit 102 of the measuring toroid is connected in parallel with a charging resistor Rc of the input circuit 6. The input circuit charging resistor Rc determines the maximum sensitivity of the processing unit 2 and consequently the minimum current threshold of the protection device. This threshold will be able to be modified with the corresponding setting adjustment means for adjusting 7. Two “head-to-tail” diodes 11 are placed in parallel with the charging resistor Rc to protect the trip circuit 4 from voltage peaks observed at the level of the current sensors 1.

The means for adjusting the fault current threshold setting 7 comprise switching means 22 having a common point C connected to a reference line V0 or ground and connected to outputs, at least a first minimum time delay selection output being connected to the means for adjusting the time delay setting 9 to supply a minimum time delay control signal, at least a second fault current threshold selection output being connected to at least one rating change resistor 12.

Said minimum time delay selection output connected to the time delay input T of the trip circuit 4 is polarized by a polarization line V2.

Preferably, said switching means 22 comprise a contact 21 able to take at least two positions. Among these positions, at least a first position P1 enables the minimum time delay selection output to be connected to the time delay input T of the trip circuit 4. According to the embodiment described, the contact 21 of the switching means 22 is then on the position P1. In addition to the first position P1 which enables the time delay input T of the trip circuit 4 to be grounded, other positions P2, P3, P4 enable resistors 12 of different values, to be fitted in parallel with the current sensors 1 and the charging resistor Rc of the input circuit 6, to be connected. Preferably, the switching means 22 are formed by an axially-operated rotary selector switch.

To increase the value of the accepted fault current threshold, said switch is positioned so as to connect a rating change resistor 12 in parallel with the charging resistor Rc. The equivalent resistance of the assembly is then lower and a higher differential current is required for the trip circuit 4 to be able to send an order. Each position of the selector switch then enables a maximum accepted differential current value to be set and thus changes the current threshold.

The means for adjusting the time delay setting 9, as represented in FIG. 3, comprise a resistor 13 mounted in series with a capacitor 14 connected to the ground of the circuit. The charging time of the time delay capacitor 14 determines the duration of the time delay. This charging time depends essentially on the values of the resistor 13 and capacitor 14. According to this embodiment, a variable resistor 13 enables the required adjustment of the time delay setting to be obtained.

The time delay cancellation control means 10 comprise a comparator 15 supplied between a voltage V2 and ground. The output voltage of said comparator commands turn-on or turn-off of a switching transistor 16. In the embodiment of FIG. 3, the transistor 16 is connected in series with the time delay capacitor 14 of the means for adjusting the time delay setting 9. Preferably, the transistor is placed between the capacitor 14 and ground or the reference line V0 of the circuit. Depending on the voltage applied between the base and the emitter of the transistor 16, the capacitor 14 of the means for adjusting the time delay setting 9 will be grounded or floating.

The rectifier and peak detection circuit 8 comprises a full-wave rectifier 17. An electronic rectifier without threshold notably formed by two operational amplifiers, not shown, is preferably used. The rectifier is connected to a comparator 18 by a peak detector 19. The comparator 18 is supplied between a voltage V2 and ground. In addition, the peak voltage is applied to one of the inputs of the comparator 18 to be compared with a reference voltage VR1. The value of the reference voltage is comprised between the value V2 and zero. Thus, if the peak voltage applied to the positive terminal of the comparator 18 is greater than the reference voltage VR1, an output voltage is close to the voltage V2. Furthermore, if the peak voltage is less than the reference voltage VR1, the voltage at the output of the comparator 18 is zero.

The output voltage of the comparator 18 is then applied to the means for adjusting the time delay setting 9. Thus, depending on the value of the preset time delay, the trip circuit 4 can send an order more or less quickly. If the value of the variable resistor 13 is low, the trip circuit 4 reacts quickly. When the value of the resistor 13 is high, a large time delay occurs between the time when the peak voltage is equal to the reference voltage and the time when the trip circuit 4 sends an order.

A comparator 20 identical to those previously described is placed between the output of the means for adjusting the time delay setting 9.

The particularity of the processing unit 2 more specifically concerns the means for adjusting the current threshold setting 7 which comprise a selector switch 22 having a contact 21 able to take at least 2 positions. This selector switch 22 in fact has the particularity of having at least one position, notably the position P1, for which the minimum or reduced time delay value and the fault current threshold value are adjusted concomitantly. This adjustment of the minimum or reduced time delay value is imposed whatever the time delay value initially set by the corresponding setting adjustment means 9. In the embodiment, when the contact 21 of the selector switch 22 is on the position P1, the differential fault current rating is set to 30 mA and the time delay is forced to 0 seconds. This setting then meets the requirements of the standards which impose that differential protection devices intended for protection of human beings force their time delay to 0 seconds for the minimum rating of 30 mA.

Operation of the protection device according to FIGS. 2 and 3 is as follows:

When the minimum rating is selected for the purposes of protecting human beings, the contact 21 of the selector switch 22 is placed on the position P1. The ground potential of the point C of the selector switch 22 is then applied at the level of the time delay input of the trip circuit 4. In practice, the voltage Vt applied to a first input of the comparator 15 of the cancellation control means 10 is zero. Knowing that the value of the reference voltage VR2 applied to the second input of the comparator is comprised between 0 and V2, the value of the input voltage is then less than the reference voltage VR2. The output voltage of the comparator 15 is then equal to 0. The transistor 16 is not actuated and is therefore not on. It is equivalent to an open switch. The time delay capacitor 14 of the means for adjusting the time delay setting 9 is no longer grounded which has the effect of cancelling the time delay value. The cancellation control means 10 have therefore sent a time delay value cancellation order.

In addition, placing the contact 21 of the selector switch 22 on the position P1 isolates all the rating change resistors 12 connected in parallel with the charging resistor Rc. The measurement voltage Vm is measured at the terminals of a maximum equivalent resistance equal to the charging resistor Rc.

Thus, as soon as a differential current greater than the minimum current is detected at the level of the current sensors 1, the corresponding voltage Vm applied to the trip circuit 4 will cause almost instantaneous sending of a control order.

When a rating different from the minimum rating has been chosen, the contact 21 of the selector switch 22 is then placed on a different position from that described above. The voltage applied to the time delay input T of the trip circuit 4 is then different from zero. The input T is no longer connected to the reference line V0. Thus, the voltage Vt applied to the first input of the comparator 15 of the cancellation control means 10 is equal to V2. The voltage V2 is applied via the polarization resistor R1. The value of the reference voltage VR2 applied to the second input of the comparator 15 being comprised between 0 and V2, the output of the comparator 15 commands the base of the switching transistor 16 and turns said transistor on. The switching transistor 16 is then equivalent to a closed switch. The time delay capacitor 14 of the time delay setting adjustment means is thus grounded and participates totally in the time delay value. The time delay cancellation control means 10 have therefore not sent a time delay value cancellation order and therefore do not have any influence on the duration of the time delay.

In addition, when the contact 21 of the selector switch 22 is in the position described above different from the position P1, the voltage Vm is then measured at the terminals of an equivalent resistance equal to the sum of the charging resistor Rc with a rating change resistor 12 in parallel.

Thus, as soon as a differential current corresponding to the fault current threshold is detected at the level of the current sensors 1, the trip circuit 4 will send an order more or less rapidly after the fault current has occurred. In this case, the value of the time delay is then chosen according to the value of the variable resistor 13 of the corresponding adjustment means.

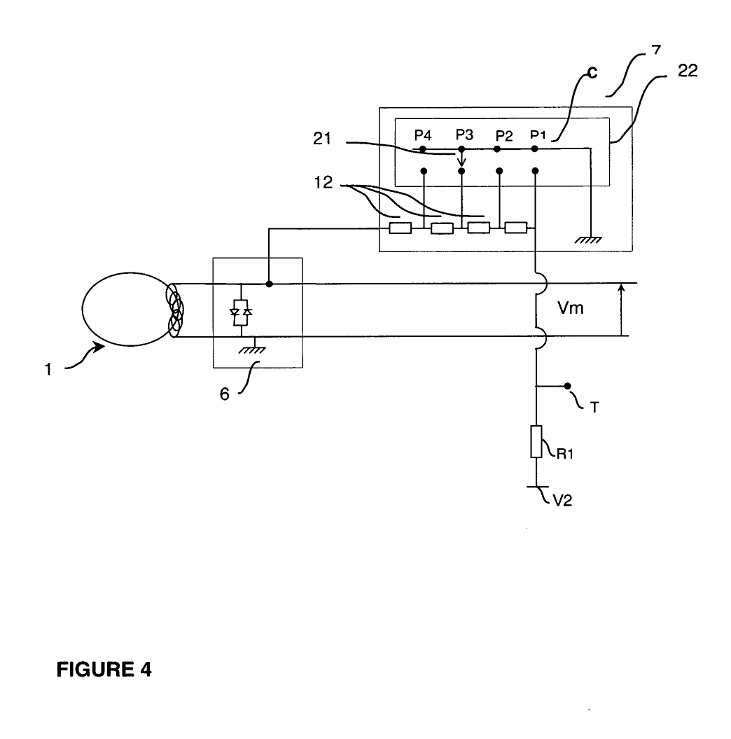

According to a first alternative embodiment represented in FIG. 4, the rating change resistors 12 associated to the different positions of the contact 21 of the selector switch 22 are respectively connected in series with respect to the measuring means 1. The minimum rating corresponds to the position of the selector switch where none of said rating change resistors 12 are short-circuited. The value of the equivalent resistor at the terminals whereof the voltage Vm is measured is then maximum and corresponds to a maximum sensitivity. The equivalent charging resistance is equal to the sum of all the resistors 12 connected in series.

According to a second alternative embodiment, the switching means 22 can be formed by a laterally-operated selector switch.

According to another alternative embodiment, the means for adjusting the time delay setting 9 comprise a resistor 13 mounted in series with a variable capacitor connected to the ground of the circuit. The variable time delay capacitor enables the required time delay setting to be obtained.

According to an alternative embodiment of the invention, the switching transistor 16 can be connected in parallel with the variable resistor 13 of the means for adjusting the time delay setting 9.

The reference voltages of the inputs of the comparators VR1, VR2, VR3 can advantageously be of the same value and have a voltage comprised between the voltage of the reference line V0 or ground and the supply or polarization voltage V2.

The controlled switch function performed by the bipolar transistor 16 can also be achieved by a field effect transistor (FET) or a relay.

Other positions of the contact 21 of the switching means 22 different from the position P1 can also enable the time delay selection output to be connected to the time delay input T of the trip circuit 4.

The present differential protection device is particularly designed for electric circuit breakers or switches. When the processing unit 2 is installed in a differential switch or associated with a circuit breaker, the operating order sent by the trip circuit 4 is intended for a breaking device of the electric current lines 3. The operating order sent to the operating relay 31 opens contacts 30 by means of an operating mechanism 32. Said contacts 30 are placed in series with the electric current lines 3.

A device according to the invention can be designed to measure polar currents in electric current line conductors. The measuring toroid will then be replaced by current sensors respectively placed around each conductor. A differential fault current signal is then reconstituted in a processing unit having means for adjusting the current threshold setting operating as in the above embodiments.

1. Differential protection device comprising:
differential current measuring means, and
a processing unit comprising means for adjusting the fault current threshold setting and means for adjusting a time delay setting, the processing unit being connected to said measuring means to receive a signal representative of a differential current, wherein
the means for adjusting the fault current threshold setting comprise switching means having a contact able to take at least two positions to select a fault current threshold for each of the positions, and to select for at least one of said positions a minimum or reduced time delay value whatever the initial setting of the means for adjusting the time delay setting.

2. Protection device according to claim 1 wherein said switching means comprise a common point connected to a reference line and connected to outputs,
at least a first minimum time delay selection output being connected to said means for adjusting the time delay setting to supply a minimum time delay control signal,
at least a second fault current threshold selection output being connected to at least one rating change resistor.

3. Protection device according to claim 2 wherein said minimum time delay selection output is polarized by a polarization line.

4. Protection device according to claim 1 wherein the rating change resistors are connected in parallel with the current measuring means, via the contact of the switching means.

5. Protection device according to claim 1 wherein the rating change resistors are connected in series with the current measuring means, via the contact of the switching means.

6. Protection device according to claim 1 wherein said switching means are formed by an axially-operated rotary selector switch.

7. Protection device according to claim 1 wherein the means for adjusting the current threshold setting select said minimum time delay value by supplying a minimum time delay control signal to time delay cancellation means of the processing unit.

8. Protection device according to claim 7 wherein the means for adjusting the time delay setting comprise a variable resistor mounted in series with a capacitor connected to a reference line and the time delay cancellation means command opening or closing of the connection between said capacitor and the reference line.

9. Protection device according to claim 7 wherein the time delay cancellation means comprise an input to receive the minimum time delay control signal, comparison means to compare said control signal with a reference threshold and interruption means connected in series with the time delay capacitor to reduce or cancel the time delay of a trip.

10. Circuit breaker comprising opening contacts connected to electric current lines and a relay to command opening of said contacts via a mechanism comprising a differential protection device according to any one of the foregoing claims comprising, differential current measuring means arranged on said current lines, a processing unit supplying a trip signal to said relays if a fault is detected and means for adjusting the current threshold setting having a position to select a minimum time delay value.
